(19) United States
(12) Patent Application Publication
(10) Pub. No.: US 2018/0373208 A1
(43) Pub. Date: Dec. 27, 2018

(54) COST FUNCTION DESIGN SYSTEM, COST FUNCTION DESIGN METHOD, AND COST FUNCTION DESIGN PROGRAM

(71) Applicant: NEC CORPORATION, Tokyo (JP)

(72) Inventors: Wemer WEE, Tokyo (JP); Yoshio KAMEDA, Tokyo (JP); Riki ETO, Tokyo (JP)

(73) Assignee: NEC Corporation, Tokyo (JP)

(21) Appl. No.: 16/062,722

(22) PCT Filed: Dec. 25, 2015
(86) PCT No.: PCT/JP2015/006474

§ 371 Date: Jun. 15, 2018

(51) Int. Cl. G05B 13/02; G05B 13/04; G06F 15/18

(52) U.S. Cl. CPC G05B 13/0265; G06F 15/18; G05B 13/042; G05B 13/048

(57) ABSTRACT

A learner unit 81 learns a quantity model for a quantity the user is interest in based on data acquired from dynamics and surroundings of a plant which is a control target. A cost function designing unit 82 designs a cost function to be used in the derivation of solutions to optimally control the plant so as to include at least the quantity model as terms.

### TECHNICAL FIELD

The present invention relates to a cost function design system, a cost function design method, and a cost function design program for designing a cost function for controlling a plant optimally.

### BACKGROUND ART

Many systems of interest to industry are dynamic and nonlinear, requiring effective and adaptive forms of control.

Conventional control techniques that have been proposed to handle such systems, e.g., those based on model predictive control disclosed in NPTL 1, are generally linear and are adaptive mainly by considering an adaptive model of the plant itself.

That is, standard adaptive control methods directly consider updating the model describing the plant's dynamics, e.g., by using system identification techniques applied on batch or online data.

However, in many applications, the change in the model may not have direct relevance to the quantity that a user wants to optimize.

Moreover, the cost functions used for the optimization of variables of interest are typically constructed manually, requiring professional experience or knowledge of first principles.

In a similar manner, it can be difficult to address situations where the plant or its components suffer from degradation, which may result in mismatches not only for the plant and its model but also for the relevant cost function terms.

Some works have attempted to solve some of the problems above. Specifically, a nonlinear adaptive controller is disclosed in PLT 1. According to PLT 1, an online neural network model that stores past system states in response to past control inputs is created.

### CITATION LIST

### Patent Literature

[PTL 1]

U.S. Pat. No. 6,185,470 B1

### Non Patent Literature

[NPL 1]

J. M. Maciejowski, Predictive Control with Constraints, Prentice Hall, 2001.

### SUMMARY OF INVENTION

### Technical Problem

A cost function or performance index which is a function of the future output states of the neural network model is then used to compute for a control output.

However, the cost function used has limited representation and the aforementioned approach provides little to no control to the end user in terms of optimizing certain variables and interpreting the process.

Indeed, it is known that the information stored inside a neural network is unreadable, and it is difficult to interpret how it is used.

Also, the cost function is highly dependent on the adaptive model of the plant. In some problems of interest however, a quantity that is desired to be optimized might change its behavior irrespective of the changes in the plant model itself.

Thus, there is a need for a method and system that can provide accurate cost function terms with richer representation learned from data that will not require manual construction and can help address changes or degradation in the operational plant.

It is also highly desirable that such a method and system provide the user more control and the ability to interpret the process or personalize the experience during plant operation.

The subject matter of the present invention is directed to realizing the above features in order to overcome, or at least reduce the effects of, one or more of the problems set forth above. That is, it is an exemplary object of the present invention to provide a cost function design system, a cost function design method, and a cost function design program capable of designing a cost function which easily allows the control of a plant to achieve a certain optimality.

### Solution to Problem

A cost function design system according to the present invention includes: a learner unit which learns a quantity model for a quantity the user is interest in based on data acquired from dynamics and surroundings of a plant which is a control target; and a cost function designing unit which designs a cost function to be used in the derivation of solutions to optimally control the plant so as to include at least the quantity model as terms.

A cost function design method comprising: learning a quantity model for a quantity the user is interest in based on data acquired from dynamics and surroundings of a plant which is a control target; and designing a cost function to be used in the derivation of solutions to optimally control the plant so as to include at least the quantity model as terms.

A cost function design program, causing a computer to execute: a learning process of learning a quantity model for a quantity the user is interest in based on data acquired from dynamics and surroundings of a plant which is a control target; and a cost function designing process of designing a cost function to be used in the derivation of solutions to optimally control the plant so as to include at least the quantity model as terms.

### Advantageous Effects of Invention

According to the present invention, a cost function which easily allows the control of a plant to achieve a certain optimality can be designed.

### BRIEF DESCRIPTION OF DRAWINGS

FIG. 1 It depicts an explanatory diagram depicting the structure of exemplary embodiment of a cost function design system according to the present invention.

FIG. 2 It depicts an explanatory diagram depicting an example of an interface displayed by the command module.

FIG. 3 It depicts an explanatory diagram depicting an example of an interface displaying details of the models.

FIG. 4 It depicts a flowchart depicting an operation example of the cost function design system in this exemplary embodiment.

FIG. 5 It depicts a flowchart depicting an operation example of the learner module in this exemplary embodiment.

FIG. 6 It depicts an explanatory diagram depicting the exemplary case that the cost function design system according to the present invention is performed in an online process.

FIG. 7 It depicts a block diagram illustrating an outline of the cost function design system according to the present invention.

### DESCRIPTION OF EMBODIMENTS

The following describes an exemplary embodiment of the present invention with reference to drawings. The preferred and alternative embodiments, and other aspects of subject matter of the present disclosure will be best understood with reference to a detailed description of specific embodiments, which follows, when read in conjunction with the accompanying drawings.

The following discussion of the embodiments of the present disclosure directed to a method and system for providing cost function models learned from data is merely exemplary in nature, and is in no way intended to limit the disclosure or its applications or uses.

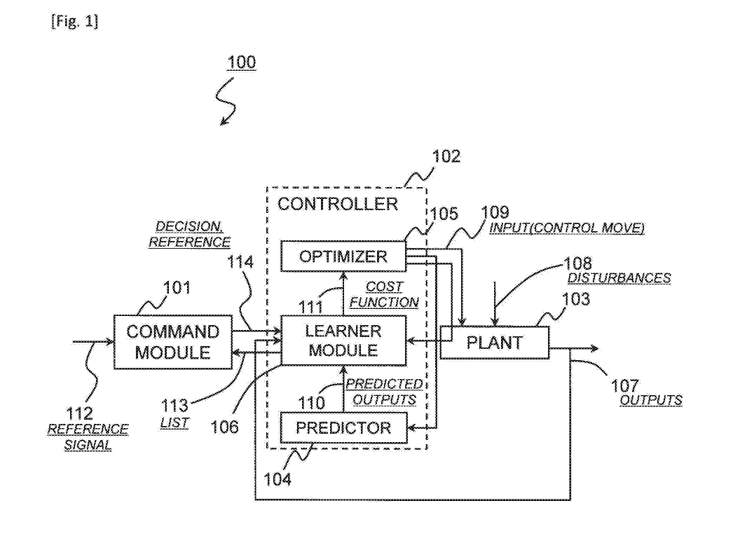

FIG. 1 is an explanatory diagram depicting the structure of an exemplary embodiment of a cost function design system according to the present invention. The cost function design system 100 according to the present exemplary embodiment includes a command module 101, a controller 102, and a plant 103. The cost function design system 100 according to the present exemplary embodiment provides adaptive control of dynamic and possibly nonlinear processes. Here, nonlinear process refers to a plant behavior or process that is described or governed by a nonlinear equation. According to the present exemplary embodiment, the controller 102 controls the plant 103.

The plant 103 sends output signals 107 to the controller 102. The output signals 107 are acquired by the sensor (not shown) of the plant 103. The plant 103 may acquire disturbances 108 as the output signals 107. The output signals 107 are used for processing or computation of the input control signals 109 used to actuate the plant 103.

The controller 102 includes a predictor 104, an optimizer 105 and a learner module 106. The predictor 104 generates predicted outputs 110 or future response signals by using a plant model. The plant model is the model that describes the behavior (e.g., motion) of the plant. For example, in the case where the plant is a vehicle, the plant model may consist of equations that describe its dynamics, i.e., the relation between its motion and the dependencies.

The predicted outputs 110 or future response signals can be included or used in the cost function 111. The cost function 111 relates to performance measures chosen by the user and constructed by the learner module 106.

Note that a number of predicted outputs 110 is generated based on a certain prediction horizon. The predicted outputs 110 are collected by the learner module 106 at each iteration, and the learner module 106 is the one to perform batch or online processing on the data collected from the predictor 104.

The optimizer 105 solves the cost function 111 subject to constraints. The optimizer 105 may solve the cost function 111 by using optimization methods such as linear or quadratic programming. The function of the learner module 106 will be described later.

The command module 101 receives decision inputs or reference signals 112 from the user, external sensors or input devices (not shown). Then, the command module 101 outputs decision and reference signals 114 to the learner module 106. Specifically, the command module 101 converts the decision and reference signals 114 in a form usable to the learner module 106. In this embodiment, the decision signal is a signal indicating whether the process of updating the cost function 111 performs automatically or manually. The reference signal is part of a parameter used in the optimization.

The command module 101 also receives the list of learned models 113 and the cost function 111 from the learner module 106, and displays them. As the list of learned models 113 is used as terms of the cost function 111, sometimes the list of learned models 113 is denoted as a cost function term in the following description. The cost function term is a function of the input and possibly some other variables that are involved in the plant operation.

Then, the command module 101 displays a list of learned cost function terms, and analytics results to the user. Specifically, the command module 101 accepts a model selecting instruction indicating whether to exclude from or include in the cost function from a user. The command module 101 also solicits user input to aid in making decisions regarding the optimization of the plant operation. Then, the command module 101 sends the model selecting instruction to the learner module 106.

Also, the user can choose whether to update the cost function 111 manually or automatically. This can improve personalization or customization of the user experience when using the plant 103. The command module 101 can also be equipped or combined with visualization techniques to enhance its usability. Examples of an interface displayed by the command module 101 will be described later.

The learner module 106 designs the cost function 111 to be used in the derivation of solutions to optimally control the plant 103. Specifically, the learner module 106 learns a model which for a quantity the user is interest in based on input-output data. In the following description, the model learned by the learner module 106 is denoted as a quantity model. The contents of the learned model are described below. The learner module 106 designs the cost function 111 so as to include at least the quantity model as terms.

The cost function model represents the quantities that a user wants to optimize but which may not necessarily be the central or the main variables to be controlled in the plant 103. For example, a cost function model can be related to fuel consumption, which the user may want to minimize but which is possibly not the main variable to be controlled during the plant's operation.

The learner module 106 is supplied collected data of plant 103 and its surroundings, together with plant 103 responses and control inputs. In particular, the learner module 106 has as inputs the decision and reference signals 114 from the command module 101, the input control signals 109 indicating a control move from the optimizer 105, the predicted outputs 110 from the predictor 104 and the output signal 107 from the plant 103.

The learner module 106 outputs at each iteration a cost function 111 for use by the optimizer 105. The learner module 106 also outputs a list of learned models 113, that is the quantity models, to the command module 101.

Moreover, the learner module 106 learns a model instructed to be included in the cost function by the selecting instruction.

Specifically, the learner module 106 constructs models (the quantity models) as functions of input signals and/or other outputs using machine learning techniques such as model estimation methods. Then, the learner module 106 designs or updates the cost function by combining newly constructed models, any pre-defined terms and other existing cost function terms as the terms of the cost function 111.

If the decision signal indicates automatically operated, the learner module 106 may update the cost function 111 to add, remove or replace cost function terms with learned ones according to user's instructions via the command module 101. On the other hand, if the decision signal indicates manually operated, the learner module 106 may design or update the cost function 111 to add a new learned term automatically. The learner module 106 may update the cost function 111 to add the learned term in the case the learned term's accuracy reaches some prescribed threshold.

Furthermore, the cost function 111 need not include all of the models or terms described above. The cost function 111 need only include some of the models or terms.

The learner module 106 may generate the cost function 111 by adding terms or models. By representing the cost function 111 in linear or quadratic form, it is possible to streamline the process of the optimizer 105. The learner module 106 may also perform a predetermined conversion and weighting for the terms or models combined.

In the exemplary embodiment of the present invention, when receiving the list of learned models 113 from the learner module 106, the command module 101 gives the user an easy way to affect or control the optimization of the plant 103, without requiring deep or professional knowledge of the system 100 or its processes.

In general cases, the model of the quantity to be optimized has to be constructed from first principles, i.e., based on some theoretical models of the quantity. However, in the exemplary embodiment, a model of the quantity to be used as part of the cost function is obtained automatically using machine learning techniques. Therefore, it is possible to optimize the plant 103 without any knowledge about the nature of the quantity.

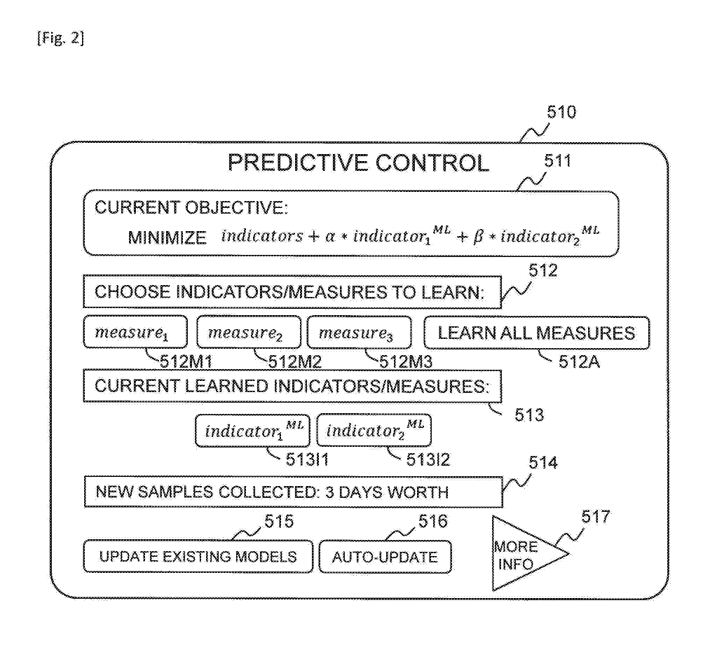

FIG. 2 is an explanatory diagram depicting an example of an interface displayed by the command module 101. The command module 101 displays the current cost function 111 used in the optimizer 105 on top of the interface 510 (see area 511), displaying also the relative importance between the terms. In the example depicted in FIG. 2, coefficients of each indicator (alpha beta) indicate the relative importance between the terms.

The command module 101 displays the different quantities (see area 512) for which data are being collected. The list here is an output of the module, but can also work as a means of input. The command module 101 may display as output the individual measures (see area 512M1-512M3). For example, when a measure is chosen by the user (via an input method, e.g., clicking the corresponding button), the command module 101 may display how the measure depends on other variables of the plant 103. The information can be used for guiding the user on whether to choose the learning of the measure or not. The input decision of the user here will be sent to the learner module 106.

The command module 101 may also display the content indicating learning of all measures (see area 512A). In this case, the command module 101 may find models for all measures in terms of the variables of the plant 103 if possible.

The command module 101 displays the list of learned performance indicators (see area 513, 513I1-513I2). The list of the indicators that have been chosen by the user, and sent from the learner module 106. The command module 101 may display details of the models for the indicators so that the interested user might be able to check.

In addition, the command module 101 displays a collection period of new samples (see area 514), whether to update an existing models (see area 515), and updating automatically or manually (see area 516). The command module 101 may also display additional information (see area 517).

Here, each item depicted in FIG. 2 is described in correspondence to the case of autonomous driving. In autonomous driving, the “indicators” in the cost function 111 refers to the distance of the car from its target and/or a change in acceleration penalty. The terms “indicator*^{ML}” refer to the learned objective terms such as fuel consumption, horizontal jerk, etc. The “measure” refers to quantities such as vibration for which data can or are being collected but models are yet to be learned. Once a model is learned, it will appear in the list 513.

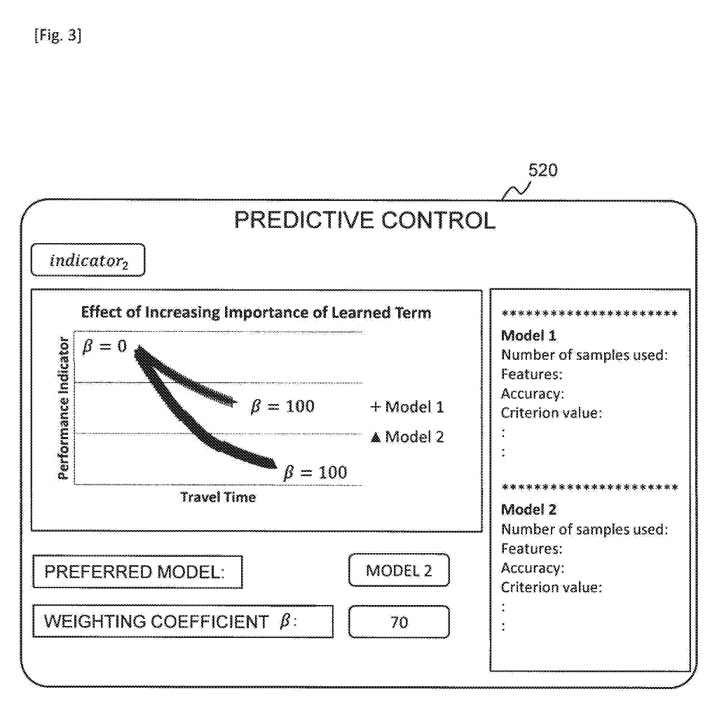

FIG. 3 is an explanatory diagram depicting an example of an interface displaying details of the available models for the chosen indicator. FIG. 3 depicts the case where the “indicator₂” is selected in FIG. 2. Moreover, FIG. 3 depicts an “Expert Mode” in which some technical details about the learned models for the desired performance measures are displayed.

The command module 101 displays simulated (or historical) effect of the use of the learned model as part of the cost function 111 as analytics results. This output can guide the user in choosing an appropriate weight for the indicator.

In the example depicted in FIG. 3, a performance indicator is set on the vertical axis and a travel time is set on the horizontal axis, and when changing beta from 0 to 100, the command module 101 displays the transition of Model 1 and Model 2 for the chosen indicator. In addition, the command module 101 displays details of the models obtained for each indicator chosen by the user (new and existing). The details of the models are received from the learner module 106. In the example depicted in FIG. 3, the details of Model 1 and Model 2 are displayed.

Based on the details of the models (accuracy, possible over-fitting, realistic dependence on features etc.), the user (expert) can choose which model will be used to represent the performance indicator, and also its weight relative to other terms. The command module 101 may accept a selection of models from the user, and send this decision to the learner module 106 for the processing of the cost function 111. In the example depicted in FIG. 3, Model 2 is chosen as the preferred model, 70 is selected as the weighting coefficient beta.

The interface will allow the user to choose the weight of the learned term and decide which model to use based on the features, accuracy measures (e.g., mean squared error), etc.

Though the cost function design system 100 according to the present exemplary embodiment includes the plant 103, the plant 103 may not be included in the cost function design system 100 of the present invention. In this case, the controller 102 may transmit control signals 109 to other devices (not shown), and receive output signals 107 from the devices.

The command module 101 and the controller 102 are realized by a CPU of a computer operating according to a program (cost function design program). For example, the program may be stored in a storage unit (not shown) in the cost function design system 100, with the CPU reading the program and, according to the program, operating as the command module 101, and the controller 102. The functions in the cost function design system of the present invention may be provided by SaaS (Software as a Service) type.

The command module 101 and the controller 102 may each be realized by dedicated hardware. Alternatively, the command module 101, and the controller 102 may each be realized by generic or specific circuitry. Here, the generic or specific circuitry may be constituted by a single chip or may be composed of a plurality of chips connected via a bus. Furthermore, if some or all of the constituent elements of each device is realized by a plurality of information processing devices or circuits, the plurality of devices or circuits and the like may be centrally located, or may be distributed. The devices and circuits, etc. may be realized as a form to be connected respectively via a communication network such as a client and server system, cloud computing system, etc.

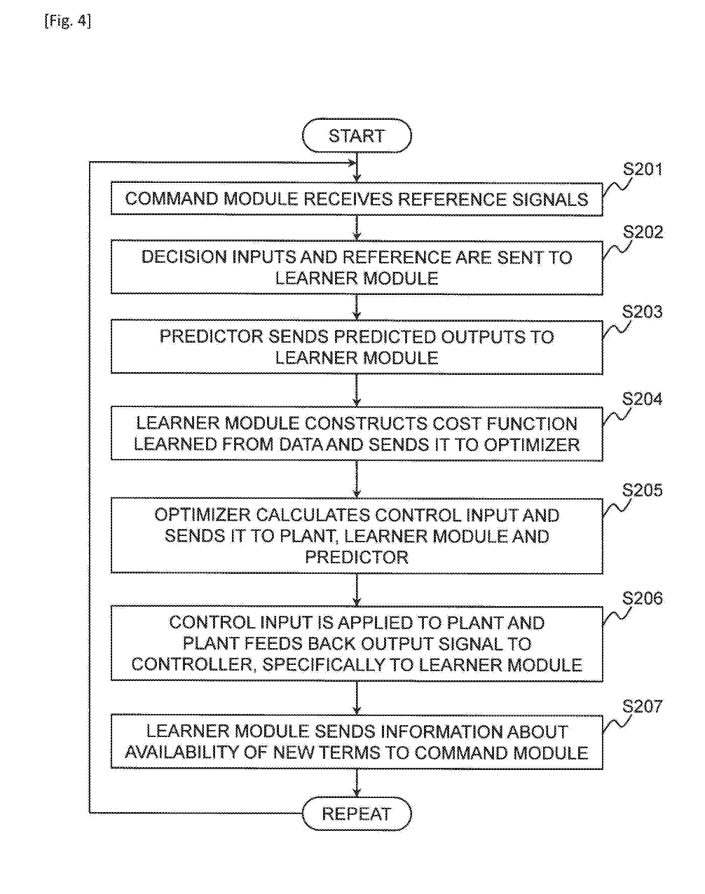

The following describes an example of the cost function design system in this exemplary embodiment. FIG. 4 is a flowchart depicting an operation example of the cost function design system in this exemplary embodiment.

First, at step S201, the command module 101 receives reference signals 112 which include target values to be used for tracking and information about the user's preferences. At step S202, the command module 101 sends decision and reference signals 114 to the learner module 106. The decision and reference signals 114 may include options chosen by the user related to the control of the plant 103. The options include information about the choices or decisions on issues such as use of a specific learned model, the adjustment of the relative importance between the cost function models (e.g., via tuning of parameters), the use of learning type (e.g., batch, online etc.) or the automation of the processes.

On the other hand, at step S203, the predictor 104 calculates predicted outputs 110 by using the plant model and sends them to the learner module 106 for processing. At step S204, once receiving data, the learner module 106 constructs a cost function 111 using terms learned from data and sends it to the optimizer 105.

At step S205, the optimizer 105 solves the cost function 111 to calculate desired control signals 109. Then the optimizer 105 sends the control signals 109 to the plant 103 for actuation, to the learner module 106 for learning, and to the predictor 104 for calculation of the theoretical outputs.

Then, at step S206, control signals 109 is applied to the plant 103, and the plant 103 feeds back the output signals 107 to the controller 102, specifically to the learner module 106. At step S207, the learner module 106 sends information about the availability of new terms to the command module 101. Thereafter, the processes from step S201 to step S207 are repeated as long as the control scheme is required.

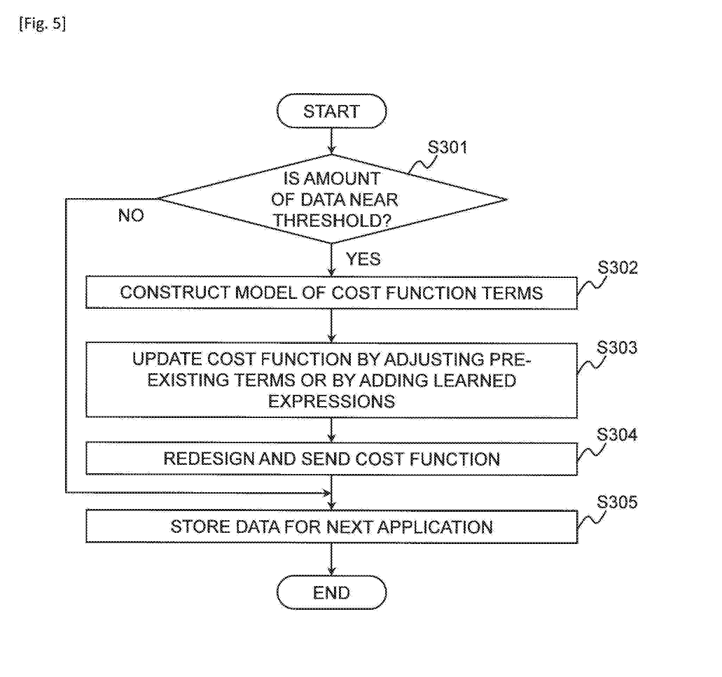

Next, the following describes an example of the learner module 106 in this exemplary embodiment. FIG. 5 is a flowchart depicting an operation example of the learner module 106 in this exemplary embodiment.

At step S301, The learner module 106 considers at each iteration the amount of data available. Specifically, the learner module 106 judges whether the amount of data is near the threshold. If the data is not near the threshold (No in step S301), the process proceeds to step S305. If the data is near the threshold (Yes in step S301), the process proceeds to step S302. “Near the threshold” indicates that the difference between the threshold and the data amount is within a predetermined range.

Furthermore, depending also on the choice of whether to use batch or online learning, the learner module 106 may decide to just store data for the next application of the method, going directly to step S305. Specifically, the learner module 106 may decide to just store data when the batch learning is selected.

At step S302, The learner module 106 starts construction of the models of cost function terms using machine learning techniques, e.g., model estimation methods. The constructed term is a function of control inputs and possibly of other plant outputs, such as output signals 107, disturbances 108, control signals 109 and predicted outputs 110.

The start of the construction of the models of cost function terms depends on the choice between batch and online learning. It means that the machine learning algorithm is applied on the available data to construct a cost function model, in batch or online fashion. Specifically, in batch learning, the learner module 106 applies the algorithm once the amount of data or the number of samples exceeds a certain threshold. In online learning, the learner module 106 applies the algorithm as soon as a new sample arrives.

At step S303, once learning a cost function term model, the learner module 106 updates the cost function 111 by adding the learned expressions or adjusting pre-existing terms. The learner module 106 may choose not to update the cost function 111 based on decision signals obtained from the command module 101.

At step S304, the learner module 106 designs the cost function 111. The design of the cost function is completed by considering combinations of pre-existing terms and learned models, and using updated versions of the terms when available. Moreover, the learner module 106 may construct or choose automatically optimal combinations of cost function terms using error quantities calculated from collected data. Then the learner module 106 sends the redesigned cost function 111 to the optimizer 105.

At step S305, the learner module 106 stores data for next application.

As described hereinabove, according to this exemplary embodiment, the learner module 106 learns the quantity model for a quantity the user is interest in based on data acquired from dynamics and surroundings of the plant 103, and designs a cost function 111 to be used in the derivation of solutions to optimally control the plant 103 so as to include at least the quantity model (cost function terms) as terms. Therefore, a cost function which easily allows the control of a plant to achieve a certain optimality can be designed.

In the exemplary embodiment, the predicted outputs 110 or future response signals are allowed to be generated in an online process.

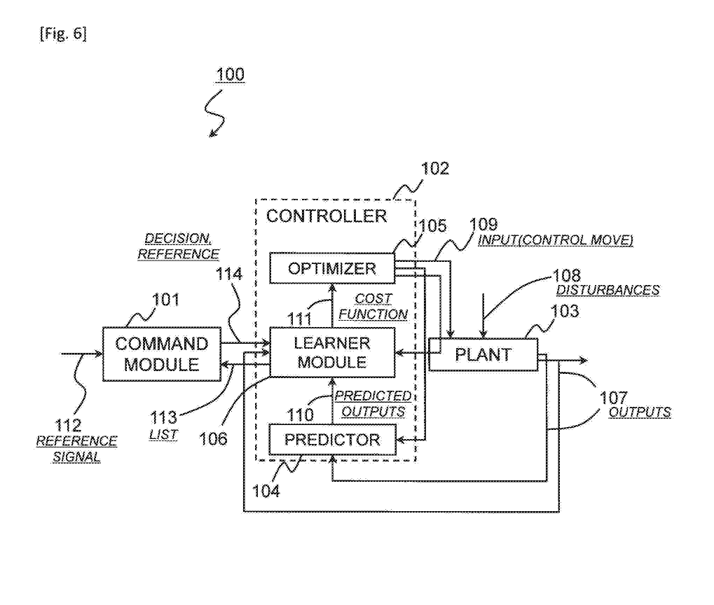

FIG. 6 is an explanatory diagram depicting the exemplary case that the cost function design system according to the present invention is performed in an online process. In this case, the plant 103 feeds back the output signals 107 not only to the learner module 106 but also to the predictor 104 for learning. Therefore, the cost function design system of the present exemplary embodiment can be used with existing adaptive control systems as described in PTL 1.

The learner module 106 may employ batch or online machine learning techniques to construct models of cost function terms. Also, the learner module 106 may use local computing, i.e., it can be store data and perform computations locally, or it can also be internet-based, so that it uses cloud computing.

Use of the learner module 106 allows the avoidance of manually considering cost function terms and it can address possible mismatches that may result from the degradation of the plant or its components, especially when automated.

Moreover, the combination of the two modules (i.e., the command module 101 and the learner module 106) allows personalization or customization of preferences during plant operation, which may vary from user to user. This is because the user can choose whether to employ (manually or automatically) learned cost function models or not. Also, the user can choose directly a quantity for which a model is desired to be used.

Moreover, the user can provide or control the relative importance between the predefined and learned cost function terms. All of the above can be achieved using some interface in the command module 101, which closely interacts with the learner module 106, leading to personalized control of the plant 103. The command module 101 and learner module 106 can also be made to automatically interact with each other based on an initial decision input from the user.

### EXAMPLE 1

In one preferred exemplary embodiment, the plant 103 represents a vehicle, which has at least one actuator input (corresponding to the control signals 109), e.g., longitudinal and lateral acceleration. The plant 103 is also subject to different disturbances 108 such as road and weather conditions. The plant's dynamics can be described using equations based on first principles. The equations can then be used in the predictor 104 to generate predicted vehicle values (corresponding to the predicted outputs 110). In this example, an important variable of interest is fuel consumption, which is dependent on quantities such as acceleration, velocity and so on.

The cost function design system 100 receives, via the command module 101, reference signals 112 such as road signs and GPS signals. The cost function design system 100 also receives decision signals 112 on whether to optimize automatically or manually once a fuel consumption model is constructed. In addition, the fuel consumption model corresponds to the quantity model of the exemplary embodiments described above.

The learner module 106 on the other hand uses the decision and reference signals 114 together with the predicted outputs 110 such as velocity values calculated by the predictor 104, the input acceleration signals (corresponding to the control signals 109) from the optimizer 105 and the output signals 107 from the plant 103 such as velocity, amount of fuel, jerk, and temperature to construct a model for fuel consumption, which can be used as part of the cost function 111. Note that the fuel consumption term can be used with typical performance measures such as target tracking or acceleration smoothing terms that may already exist.

The use of the learner module 106 gives the user a way to update the fuel consumption model in the cost function 111 of the system 100 without having to go to customer centers for servicing. The vehicle manufacturer can also improve its service to the user by being able to use data or analytics results collected from the learner module 106. Also, the user can, via the command module 101, disable or enable at any time the use of a fuel consumption term once the expected performance deteriorates or if an anomaly occurs.

The aforementioned processes can run automatically and optimize fuel without drastically affecting the dynamics of the vehicle, which might be caused, for instance, by changing the model of the plant's dynamics.

### EXAMPLE 2

In another preferred exemplary embodiment, this example 2 resembles previous example 1. The variable of interest is related to comfort of the vehicle's driver or passengers. In this example 2, the quantity to be optimized can be jerk, which can be controlled or suppressed using optimal choices of the acceleration input (corresponding to the control signals 109).

The use of the learner module 106 and the command module 101 in this case provides the user a way to personalize the effect of jerk to match their own preferences. Preferences related to comfort are highly subjective and depend heavily on the users. The example 2 of the present invention allows high customization, and provides a control loop, for the optimization of comfort to meet users' needs or expectations.

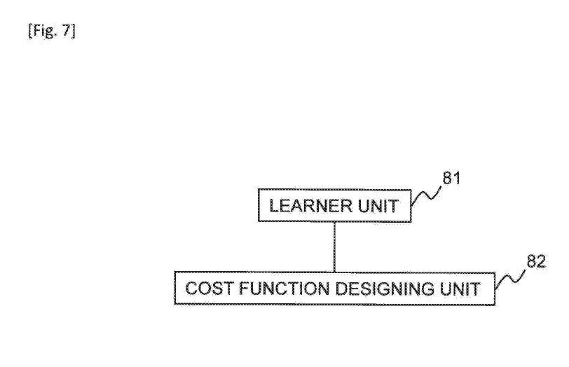

The outline of the present invention will be described. FIG. 7 is a block diagram illustrating an outline of the cost function design system according to the present invention. The cost function design system according to the present invention includes a learner unit 81 (for example, learner module 106) which learns a quantity model (for example, cost function term model) for a quantity the user is interest in based on data acquired from dynamics and surroundings of a plant (for example, plant 103) which is a control target; and a cost function designing unit 82 (for example, learner module 106) which designs a cost function (for example, cost function 111) to be used in the derivation of solutions to optimally control the plant so as to include at least the quantity model as terms.

According to the above configuration, a cost function which easily allows the control of a plant to achieve a certain optimality can be designed.

Furthermore, the cost function design system may include an optimizer (for example, optimizer 105) which optimizes the designed cost function, and the optimizer may output a control signal based on the optimization result to the plant. According to the configuration, it is possible to dynamically optimally control the plant.

Furthermore, the cost function design system may include a command unit (for example, command module 101) which receives the designed cost function and learned models. The command unit may display the received cost function and learned models, accept a model selecting instruction indicating whether to exclude from or include in the cost function from a user, and send the model selecting instruction to the learner unit. Moreover, the learner unit 81 may learn a model instructed to include the cost function by the selecting instruction, and the cost function designing unit 82 may design the cost function including the learned model. According to the configuration, it is possible to optimally control while reflecting the intention of the user. According to the above configuration, a cost function which has high interpretability and easily allows the control of a plant to achieve a certain optimality can be designed.

Furthermore, the learner unit 81 may design or update the cost function so as to combine the new learned model, pre-defined term and existing quantity models as the term of the cost function.

Furthermore, the cost function design system may include a predictor (for example, predictor 104) which generates a prediction result of the plant by using a plant model describing a behavior of the plant. The learner unit 81 may learn the cost function using the predicted result. According to the configuration, it is possible to learn a model using a variable other than the control target.

The foregoing description of preferred and alternative embodiments is not intended to limit or restrict the scope or applicability of the inventive concepts of the present disclosure. One skilled in the art will readily recognize from such discussion and from the accompanying drawings and claims that various changes, modifications and variations can be made therein without departing from the spirit and scope of the disclosure as defined in the following claims.

### REFERENCE SIGNS LIST

101 command module

102 controller

103 plant

104 predictor

105 optimizer

106 learner module

107 output signal

108 disturbance

109 control signal

110 predicted output

111 cost function

112 decision or reference signal

113 list of learned models

114 decision and reference signals

What is claimed is:

1. A cost function design system comprising:
a hardware including a processor;
a learner unit, implemented at least by the processor, which learns a quantity model for a quantity the user is interest in based on data acquired from dynamics and surroundings of a plant which is a control target; and
a cost function designing unit, implemented at least by the processor, which designs a cost function to be used in the derivation of solutions to optimally control the plant so as to include at least the quantity model as terms.

2. A cost function design system according to claim 1, further comprising:
an optimizer, implemented at least by the processor, which optimizes the designed cost function,
wherein the optimizer outputs a control signal based on the optimization result to the plant.

3. A cost function design system according to claim 1, further comprising:
a command unit, implemented at least by the processor, which receives the designed cost function and learned models,
wherein the command unit displays the received cost function and learned models, accepts a model selecting instruction indicating whether to exclude from or include in the cost function from a user, and sends the model selecting instruction to the learner unit,
wherein the learner unit learns a model instructed to be included in the cost function by the selecting instruction, and
wherein the cost function designing unit designs the cost function including the learned model.

4. A cost function design system according to claim 1, wherein the learner unit designs or updates the cost function so as to combine the new learned model, pre-defined terms and existing quantity models as the terms of the cost function.

5. A cost function design system according to claim 1, comprising:
a predictor, implemented at least by the processor, which generates a prediction result of the plant by using a plant model describing a behavior of the plant,
wherein the learner unit learns the cost function using the predicted result.

6. A cost function design method comprising:
learning a quantity model for a quantity the user is interest in based on data acquired from dynamics and surroundings of a plant which is a control target; and
designing a cost function to be used in the derivation of solutions to optimally control the plant so as to include at least the quantity model as terms.

7. A cost function design method according to claim 6, further comprising:
optimizing the designed cost function, and
outputting a control signal based on the optimization result to the plant.

8. A non-transitory computer readable information recording medium storing a cost function design program, when executed by a processor, which performs a method for:
learning a quantity model for a quantity the user is interest in based on data acquired from dynamics and surroundings of a plant which is a control target; and
designing a cost function to be used in the derivation of solutions to optimally control the plant so as to include at least the quantity model as terms.

9. The non-transitory computer-readable recording medium according to claim 8,
an optimizing process of optimizing the designed cost function,
wherein, in the optimizing process, a control signal is output based on the optimization result to the plant.
